(19) United States
(12) Patent Application Publication
(10) Pub. No.: US 2025/0123894 A1
(43) Pub. Date: Apr. 17, 2025

(54) AUTONOMOUS EXECUTION OF UNSTRUCTURED COMPUTE PROCESSES

(71) Applicant: Salesforce, Inc., San Francisco, CA (US)

(72) Inventor: Dustin Allen Kirk, San Diego, CA (US)

(21) Appl. No.: 18/488,831

(22) Filed: Oct. 17, 2023

(51) Int. Cl. G06F 9/50

(52) U.S. Cl. CPC G06F 9/5038

(57) ABSTRACT

A method of data processing is described. The method may include receiving an indication of one or more operational constraints for an unstructured compute process to be executed by the data processing system. The method may further include transmitting a request to decompose the unstructured compute process into a set of structured sub-processes and allocate the set of structured sub-processes to a set of compute resources of the data processing system in accordance with the one or more operational constraints. The method may further include receiving a response that contains information associated with an allocation scheme for the set of structured sub-processes of the unstructured compute process. The method may further include allocating the set of structured sub-processes to the set of compute resources and executing the set of structured sub-processes in accordance with the allocation scheme and the one or more operational constraints.

### FIELD OF TECHNOLOGY

The present disclosure relates generally to database systems and data processing, and more specifically to autonomous execution of unstructured compute processes.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things (IoT). A user may utilize the cloud platform to help manage contacts of the user. For example, managing contacts of the user may include analyzing data, storing, and preparing communications, and tracking opportunities and sales.

### BRIEF DESCRIPTION OF THE DRAWINGS

FIGS. 1 through 3 illustrate examples of data processing systems that support autonomous execution of unstructured compute processes in accordance with aspects of the present disclosure.

FIG. 4 shows an example of a process decomposition scheme that supports autonomous execution of unstructured compute processes in accordance with aspects of the present disclosure.

FIG. 5 shows an example of a performance prediction scheme that supports autonomous execution of unstructured compute processes in accordance with aspects of the present disclosure.

FIG. 6 shows an example of a constraint prioritization scheme that supports autonomous execution of unstructured compute processes in accordance with aspects of the present disclosure.

FIG. 7 shows an example of a load balancing and redundancy scheme that supports autonomous execution of unstructured compute processes in accordance with aspects of the present disclosure.

FIG. 8 shows an example of a process allocation scheme that supports autonomous execution of unstructured compute processes in accordance with aspects of the present disclosure.

FIG. 9 shows an example of a dependency management scheme that supports autonomous execution of unstructured compute processes in accordance with aspects of the present disclosure.

FIG. 10 shows a block diagram of an apparatus that supports autonomous execution of unstructured compute processes in accordance with aspects of the present disclosure.

FIG. 11 shows a block diagram of a compute process manager that supports autonomous execution of unstructured compute processes in accordance with aspects of the present disclosure.

FIG. 12 shows a diagram of a system including a device that supports autonomous execution of unstructured compute processes in accordance with aspects of the present disclosure.

FIG. 13 shows a flowchart illustrating a method that supports autonomous execution of unstructured compute processes in accordance with aspects of the present disclosure.

### DETAILED DESCRIPTION

Many industries face challenges with automating complex tasks (referred to hereinafter as compute processes), such as organizing marketing campaigns, managing supply chain logistics, handling customer inquiries, etc. Conventional methods of automating compute processes are often static and confined to structured operations (e.g., discrete workflows with pre-defined inputs, outputs, and parameters). Efficiently utilizing resources (such as time, money, and computational power) can also be a significant challenge for process automation. Conventional techniques for balancing quality, cost, and speed may be complex, expensive, and computationally inefficient. Additionally, the dynamic nature of compute processes and their constraints may require a system to adapt to conditions in real-time. Conventional systems may lack the flexibility to adjust to dynamic conditions and varying constraints. Further, many complex compute processes involve collaboration between bots (e.g., compute resources, scripts, programs, or services that are configured to perform a specific operation) and humans. Integrating artificial intelligence (AI) bots with human teams without disrupting existing workflows is a complex endeavor. Moreover, handling large-scale compute processes with redundancy (to ensure fault tolerance) presents many logistical challenges.

The techniques described herein generally provide for automating unstructured compute processes (e.g., complex, multi-faceted operations) through dynamic process decomposition and bot allocation. The described techniques leverage inter-bot coordination and large language model (LLM) capabilities to allocate tasks efficiently and effectively based on constraints (such as available time and compute resources). The compute resources (e.g., bots) responsible for decomposing, allocating, and/or executing compute processes may be monitored by a human director, and the system of compute resources may (in some implementations) be integrated with humans. The compute resources may be deployed to perform various structured sub-processes, such as crawling the internet for a discrete amount of time, searching a database for specific data, or interacting with third-party systems. The data processing system described herein may distribute structured sub-processes among AI compute resources, taking into consideration factors like time, resource availability, and cost. In particular, the data processing system may use an LLM to automatically and adaptively decompose unstructured compute processes based on process complexity, resource availability, bot capabilities, latency constraints, etc. Unlike conventional mechanisms, the data processing system may continuously monitor the progress of each compute resource, adjusting workloads and resource-specific queues in real-time to optimize overall performance.

In accordance with one or more aspects of the present disclosure, a data processing system may receive an indication of one or more operational constraints for an unstructured compute process to be executed by the data processing system. The data processing system may transmit, to an LLM that is configured to communicate with the data processing system, a request to decompose the unstructured compute process into multiple structured sub-processes and allocate the structured sub-processes to respective compute resources of the data processing system in accordance with the one or more operational constraints. The data processing system may receive, from the LLM, a response containing information associated with an allocation scheme for the structured sub-processes of the unstructured compute process. The data processing system may allocate the structured sub-processes identified by the LLM to the corresponding compute resources of the data processing system in accordance with the allocation scheme and the one or more operational constraints. Accordingly, the compute resources may execute the structured sub-processes by using the LLM to retrieve data from various data sources in accordance with the one or more operational constraints.

Aspects of the disclosure are initially described in the context of data processing systems, a process decomposition scheme, a performance prediction scheme, a constraint prioritization scheme, a load balancing and redundancy scheme, a process allocation scheme, and a dependency management scheme. Aspects of the disclosure are further illustrated by and described with reference to apparatus diagrams, system diagrams, and flowcharts that relate to autonomous execution of unstructured compute processes.

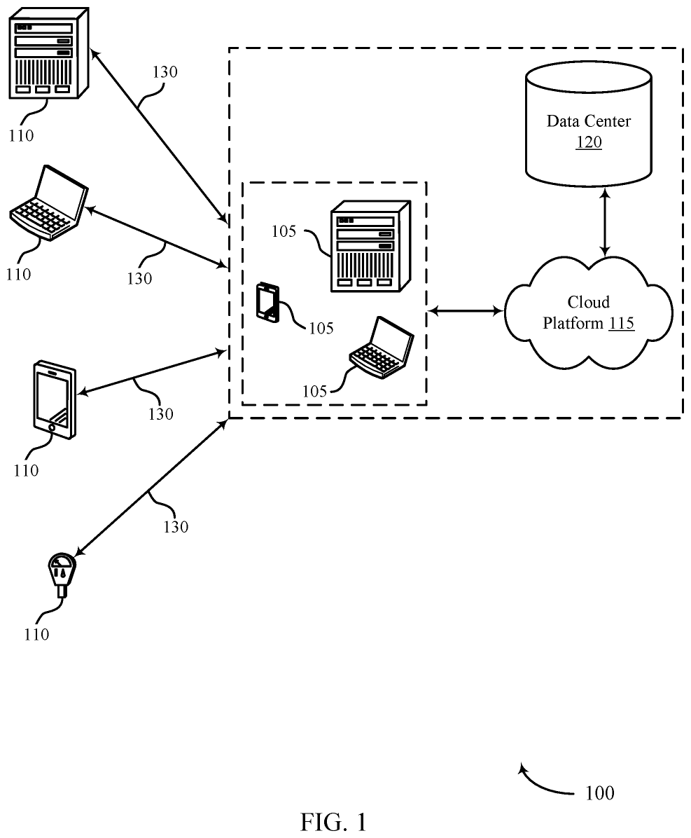

FIG. 1 illustrates an example of a data processing system 100 that supports autonomous execution of unstructured compute processes in accordance with various aspects of the present disclosure. The data processing system 100 includes cloud clients 105, contacts 110, cloud platform 115, and data center 120. Cloud platform 115 may be an example of a public or private cloud network. A cloud client 105 may access cloud platform 115 over a network connection. The network may implement transfer control protocol and internet protocol (TCP/IP), such as the Internet, or may implement other network protocols. A cloud client 105 may be an example of a user device, such as a server, a smartphone, or a laptop. In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interactions 130, such as a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server, a laptop, a smartphone, or a sensor. In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with interactions 130 from the cloud client 105 over a network connection, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via a connection, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

The data processing system 100 includes cloud clients 105, cloud platform 115, and data center 120. In some cases, data processing may occur at any of the components of the data processing system 100, or at a combination of these components. In some cases, servers may perform the data processing. The servers may be associated with a cloud client 105 or located at data center 120.

The data processing system 100 may be an example of a multi-tenant system. For example, the data processing system 100 may store data and provide applications, solutions, or any other functionality for multiple tenants concurrently. A tenant may be an example of a group of users (e.g., an organization) associated with a same tenant identifier who share access, privileges, or both for the data processing system 100. The data processing system 100 may effectively separate data and processes for a first tenant from data and processes for other tenants using a system architecture, logic, or both that support secure multi-tenancy. In some examples, the data processing system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the data processing system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the data processing system 100 may support any configuration for providing multi-tenant functionality. For example, the data processing system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The data processing system 100 may support scaling of tenants within the multi-tenant system, for example, using scale triggers, automatic scaling procedures, scaling requests, or any combination thereof. In some cases, the data processing system 100 may implement one or more scaling rules to enable relatively fair sharing of resources across tenants. For example, a tenant may have a threshold quantity of processing resources, memory resources, or both to use, which in some cases may be tied to a subscription by the tenant.

In accordance with one or more aspects of the present disclosure, the data processing system 100 may receive an indication of one or more operational constraints for an unstructured compute process to be executed by the data processing system 100. As described herein, an unstructured compute process refers to a complex, large-scale objective, such as “set up sales meetings with ten largest roofing companies in the Midwest” or “analyze performance of latest marketing campaign”. The data processing system 100 may transmit, to an LLM that is configured to communicate with the data processing system 100, a request to decompose the unstructured compute process into multiple structured sub-processes and allocate the structured sub-processes to respective compute resources of the data processing system in accordance with the one or more operational constraints. As described herein, a structured sub-process refers to a discrete operation, such as browsing a website to extract an email address for a potential lead, or querying a database for relevant sales metrics.

The data processing system 100 may receive, from the LLM, a response containing information associated with an allocation scheme for the structured sub-processes of the unstructured compute process. The data processing system 100 may allocate the structured sub-processes identified by the LLM to the corresponding compute resources of the data processing system 100 in accordance with the allocation scheme and the one or more operational constraints. Accordingly, the compute resources may execute the structured sub-processes by using the LLM to retrieve data from various data sources in accordance with the one or more operational constraints. In some implementations, the one or more operational constraints may include a limit or boundary for a given operation, such as Runtime: 5 minutes; Compute: 1000 tokens. Some operational constraints may relate to process complexity, resource availability, job priority, etc.

It should be appreciated by a person skilled in the art that one or more aspects of the disclosure may be implemented in a data processing system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

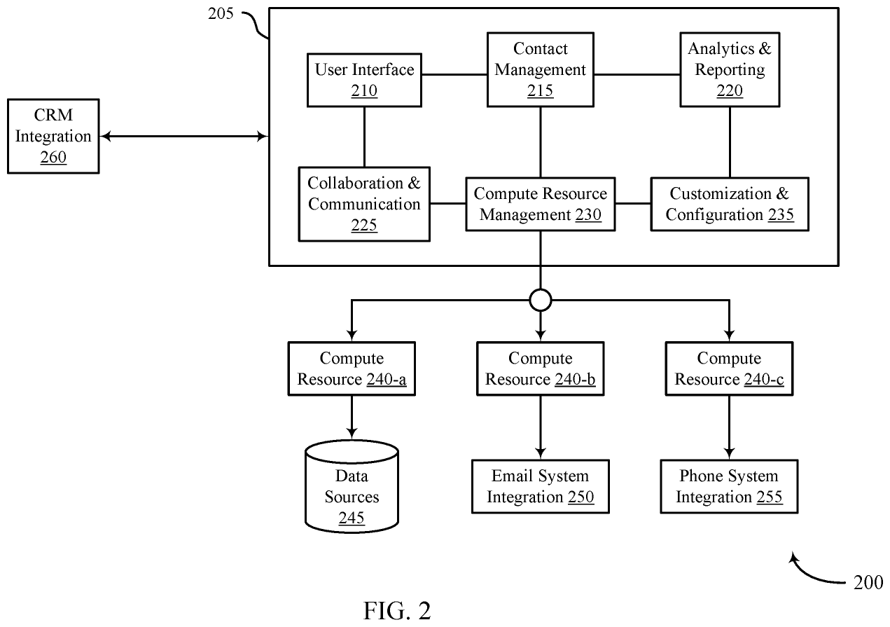

FIG. 2 shows an example of a data processing system 200 that supports autonomous execution of unstructured compute processes in accordance with aspects of the present disclosure. The data processing system 200 may implement one or more aspects of the data processing system 100. For example, the data processing system 200 includes a CRM integration 260, which may be implemented or otherwise supported by the cloud platform 115 shown and described with reference to FIG. 1. The data processing system 200 also includes an application 205 (such as a sales management application) and one or more compute resources 240 (e.g., AI bots), which may be supported or otherwise provisioned by one or more components of the data processing system 100.

The automated bot management techniques described herein provide a comprehensive approach for automating complex processes through dynamic process decomposition and bot allocation. The data processing system 200 utilizes a multitude of advancements to allocate processes efficiently and effectively based on constraints such as available time and resources. The management of compute resources 240 in the data processing system 200 may be monitored by a human director, and the system of compute resources 240 may (in some examples) be integrated with humans (to which certain processes may be assigned).

The data processing system 200 (also referred to as a bot management system) can provision compute resources 240 to perform various processes, such as crawling the Internet, searching databases, or interacting with third-party systems to accomplish the processes, which may be time intensive and/or resource intensive. The techniques described herein generally involve process allocation, adaptive process decomposition, bot performance prediction, constraint prioritization, load balancing and redundancy, and process dependency management.

The data processing system 200 may be configured to distribute compute processes among AI bots (e.g., compute resources 240). The data processing system 200 may consider various operational constraints, including (but not limited to) cost, quality, and time. The data processing system 200 may continuously monitor bot performance, making real-time adjustments to the number of bots as needed. These automation techniques can replace existing manual/static allocation methods, enhancing efficiency and adaptability. The data processing system 200 can also leverage collaboration between multiple bots, enabling them to utilize each other's capabilities.

The data processing system 200 can automatically and adaptively decompose unstructured processes based on the complexity of the process, the number of available AI bots, and their capabilities. Unlike other systems, the data processing system 200 continuously monitors the progress and overall process completion of the AI bots, adjusting process decomposition and allocation schemes in real-time to optimize performance.

The data processing system 200 may be configured to allocate structured sub-processes to AI bots by analyzing historical performance data, predicting the likelihood of success for a given process.

The data processing system 200 may leverage multi-objective optimization, context-awareness, and predictive performance to efficiently allocate compute resources 240 across a backlog of unstructured sub-processes. By continuously monitoring a project's status, adjusting its process decomposition, and adapting to changes in constraints (such as cost, quality, and time), the data processing system 200 can ensure optimal process allocation.

The data processing system 200 may be capable of dynamically balancing workloads among AI bots, while ensuring redundancy to handle failures or performance drops. The described techniques generally support dynamic load balancing, health monitoring and fault detection, process redundancy and replication, automatic process reassignment, AI bot recovery and reintegration, and performance optimization and scaling.

The data processing system 200 may be configured to manage complex process dependencies by employing a process dependency graph, a process scheduler, a priority queue, a resource allocator, a process monitor, and a feedback loop. The data processing system 200 may ensure that processes are executed in the correct order, and that resources are allocated optimally. The integration with AI bots enables automation of specific processes, enhancing efficiency and freeing human resources for strategic roles. A continuous feedback loop allows for ongoing improvements in scheduling and resource allocation.

The bot management techniques described herein can be deployed in a variety of scenarios, including (but not limited to) a sales team, where a sales manager can utilize the data processing system 200 to identify sales prospects, predict the likelihood of a prospect converting to a sale, and initiate communications with a prospect prior to handing off the sale to a human sales representative. Other deployments of the data processing system 200 and the advancements disclosed here may also be applicable to research, law, customer service, or other areas in which teams of people are given a common objective.

In some implementations, the data processing system 200 may employ an intelligent process decomposition scheme to break down complex processes into manageable sub-processes that can be efficiently allocated to specialized AI bots, thereby enabling the data processing system 200 to use parallel processing, leverage specialized expertise, and enhance overall efficiency.

In some implementations, the data processing system 200 may employ a dynamic resource allocation scheme to allocate processes to AI bots based on real-time constraints (such as cost, quality, time, and available resources). This can help the data processing system 200 ensure optimal utilization of resources, balance conflicting constraints, and adapt to changing conditions.

In some implementations, the data processing system 200 may leverage real-time adaptability to continuously monitor performance and adapt process decomposition and/or allocation in real-time. This enables the data processing system 200 to respond to unexpected changes, failures, or new information, thereby maintaining optimal performance.

The described techniques may leverage various integrations with human workflows to seamlessly integrate AI bots with human teams, enabling collaboration and process handoff. This enables the data processing system 200 to leverage human expertise (where needed), enhance collaboration, and ensure a smooth transition between automated and manual processes.

The data processing system 200 may use various scalability and redundancy schemes to build a network that can scale to handle large-scale processes and provide redundancy to ensure fault tolerance. This offers greater robustness, reliability, and the ability to handle varying workloads without performance degradation.

The techniques described herein may support cost-effective operations, thereby enabling the data processing system 200 to operate the network of AI bots in a cost-effective manner, balancing quality and efficiency. This ensures that the data processing system 200 provides value without excessive expenditure, aligning with budgetary constraints.

The system architecture diagram depicted in the example of FIG. 2 illustrates key components of the data processing system 200, such as compute resources 240 (e.g., AI bots), an application 205 (e.g., a sales management application), data sources 245, and integrations with other platforms (e.g., CRM, email, phone systems). The CRM integration 260 may enable the application 205 to integrate with existing tools, streamline data management, and ensure seamless information flow between different platforms.

The application 205 may be responsible for coordinating with AI bots, processing data, and managing overall system functionality. The application 205 may connect to the user interface 210 and be responsible for handling user inputs, processing data, and/or generating data insights. The user interface 210 may include a web or mobile-based interface via which sales managers and team members interact with the application 205. The user interface 210 may enable users to manage contacts, monitor AI bot activities, review performance metrics, and configure system settings. The user interface 210 may serve as the gateway for human directors to interact with the data processing system 200. The user interface 210 enables users to configure resource allocations, add high-level jobs, monitor performance, and view jobs in progress. The user interface 210 may be configured to provide an intuitive and user-friendly experience, allowing for easy management and oversight of the data processing system 200.

The contact management module 215 of the application 205 provides a comprehensive contact management system, enabling users to track and monitor contacts (e.g., leads), access relevant information, and update contact status as they progress through the sales pipeline. The contact management module 215 may include tools for filtering, sorting, and/or searching for contacts based on various criteria (such as lead score, industry, or deal size).

The analytics and reporting module 220 of the application 205 may provide advanced analytics and reporting capabilities, enabling sales managers to track key performance indicators (KPIs), generate insights, and make data-driven decisions. The analytics and reporting module 220 may (in some implementations) be capable of surfacing visualizations, such as charts, graphs, and customizable reports that can be exported and/or shared between users.

The collaboration and communication module 225 of the application 205 may facilitate collaboration and communication among sales team members, enabling them to share updates, discuss leads, and coordinate their efforts. The collaboration and communication module 225 may support features like messaging, file sharing, and task assignment.

The compute resource management module 230 of the application 205 (also referred to as the automated bot management sub-system) may be configured to distribute tasks among other AI bots and ensure efficient parallel execution of tasks. By automating and optimizing the task delegation process, the compute resource management module 230 may reduce the amount of time that humans spend on repetitive tasks, enabling the sales team to focus on high-value activities. The compute resource management module 230 may include various other components, such as a task decomposition module, a task prioritization module, a task allocation module, a bot performance prediction module, a task monitoring and progress tracking module, a bot training and retraining module, a constraint prioritization module, a task dependency management module, and/or a load balancing module.

The customization and configuration module 235 of the application 205 may provide a large number of customization and configuration options, allowing sales managers to configure their deployments to their specific preferences. The customization and configuration module 235 may support sales collateral services, style guides for voice and tone, voice samples, writing samples, pricing guides, product guides, and/or AI bot setting configurations for communications, task allocations, cost limits, etc.

The compute resource 240-a (e.g., a web crawler) may be configured to conduct searches of data sources 245, navigate websites, and collect/log data. The data sources 245 may include a wide range of external data sources that AI bots use to gather information, such as web pages (e.g., public websites, government websites), social media, company databases (e.g., corporate media). The data sources 245 may connect to the compute resource 240-a (e.g., the web crawling AI bot), such that the compute resource 240-a can collect and process data from the data sources 245.

The compute resource 240-b (e.g., an email automation bot) may be configured to compose and send emails by interacting with the email system integration 250 (which may utilize email systems like Gmail or Outlook to send emails). The compute resource 240-c (e.g., a call automation bot) may be configured to make phone calls by interacting with the phone system integration 255 (e.g., VoIP, PBX).

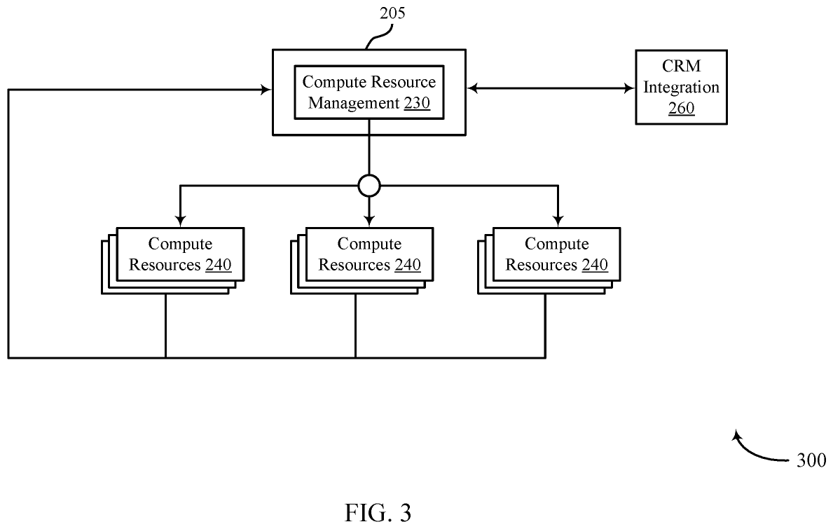

FIG. 3 shows an example of a data processing system 300 that supports autonomous execution of unstructured compute processes in accordance with aspects of the present disclosure. The data processing system 300 may implement one or more aspects of the data processing system 100. For example, the data processing system 300 includes a CRM integration 260, which may be implemented or otherwise supported by the cloud platform 115 shown and described with reference to FIG. 1. The data processing system 300 also includes an application 205 (such as a sales management application) and one or more compute resources 240 (e.g., AI bots), which may be supported or otherwise provisioned by one or more components of the data processing system 100.

Many industries have challenges automating complex processes that involve intelligent decomposition, allocation, and execution. Conventional methods are often manual, static, and inefficient. Efficiently utilizing resources (such as time, money, and computational power) can be a significant challenge. Balancing quality, cost, and time constraints typically involves sophisticated algorithms and real-time adaptability. The dynamic nature of unstructured processes and constraints requires real-time adaptability. Traditional systems lack the flexibility to adjust to changing conditions and requirements. Many unstructured processes involve collaboration between bots and humans. Integrating AI bots with human teams without disrupting existing workflows is a complex challenge. Handling large-scale processes with redundancy to ensure fault tolerance is critical. Building a system that can scale and recover from failures is non-trivial.

Traditional workflow automation systems often rely on predefined rules and static task allocation, and lack the ability to intelligently decompose tasks, adapt in real-time, or facilitate collaboration between specialized AI bots. Cloud-based task management platforms offer scalability, but may not provide intelligent task decomposition, real-time adaptability, or seamless human-bot collaboration. Robotic process automation (RPA) tools can automate repetitive tasks, but may lack the ability to handle complex, dynamic tasks that require intelligent decomposition and real-time adaptation. AI-based predictive analytics platforms can provide predictive insights, but may not offer comprehensive task management features like adaptive task decomposition, dynamic load balancing, and redundancy. Distributed computing frameworks focus on parallel processing, but may lack features like intelligent task decomposition, real-time adaptability, and human-bot collaboration. Custom-built industry-specific solutions lack the versatility and cross-industry applicability of the data processing system 300. The modular design of the data processing system 300 and the ability to adapt to various industry challenges make the data processing system 300 a more flexible and scalable solution.

In contrast to other systems, the data processing system 300 offers a comprehensive and innovative approach to complex task automation and management. Unlike traditional systems, the data processing system 300 intelligently decomposes tasks, dynamically allocates resources, and adapts in real-time. Seamless integration of AI bots with human workflows, continuous learning and improvement, enhanced bot collaboration, and cross-industry applicability make the data processing system 300 a versatile and forward-looking solution. The focus on security, compliance, and cost-effective operation further enhances the appeal of the data processing system 300. By addressing the multi-faceted challenges of task automation in a holistic manner, the data processing system 300 offers the potential to revolutionize task management across various domains.

The automated bot management techniques disclosed herein address the multi-faceted challenges of complex task automation and management in a comprehensive and innovative way. The intelligent task decomposition and dynamic resource allocation enable the system to handle complex tasks with unprecedented efficiency and adaptability. Real-time monitoring and adaptability ensure that the system can respond to unexpected changes, while human-bot collaboration enhances synergy and leverages human expertise. The scalable and redundant architecture ensures robustness, while continuous learning keeps the system up to date. Cross-industry applicability enhances versatility, and enhanced bot collaboration leverages specialized expertise. Security measures build trust, and cost-effective operation ensures value delivery. Together, these features make the data processing system 300 a transformative solution, with the potential to revolutionize how tasks are managed and executed across various domains.

The data processing system 300 may support intelligent task decomposition (e.g., breaking down complex tasks into manageable sub-tasks), dynamic resource allocation (e.g., allocating tasks based on real-time constraints), real-time adaptability (e.g., continuously monitoring and adapting to changing conditions), human-bot collaboration (e.g., seamlessly integrating AI bots with human workflows), scalable and redundant architecture (e.g., ensuring robustness and ability to handle large-scale tasks), and cost-effective operation (e.g., balancing quality and efficiency for cost-effective functioning), among other examples.

The techniques described herein can be used to address the above challenges in a variety of fields, including (but not limited to) sales and marketing, research and development, customer service, legal and compliance, supply chain and logistics, healthcare, manufacturing, education, CRM, and the like. For example, the data processing system 300 may be configured to or otherwise capable of automating prospect identification, lead scoring, and initial communication, which can significantly enhance sales efficiency. The data processing system 300 can also leverage predictive analytics to improve conversion rates.

In fields like pharmaceuticals, finance, and technology, the data processing system 300 can automate data collection, analysis, and hypothesis testing, thereby accelerating innovation and discovery. The data processing system 300 may also be configured to or otherwise capable of automating routine customer inquiries and support processes to enhance customer experience while freeing human agents to handle more complex issues. The data processing system 300 may be further configured to or otherwise capable of automating legal research, document review, and compliance checks, which can save time and reduce costs in legal firms and regulatory bodies. The data processing system 300 may be further configured to or otherwise capable of optimizing inventory management, routing, and scheduling through intelligent process decomposition and allocation, which can enhance efficiency in supply chain operations.

In some implementations, the data processing system 300 may be configured to or otherwise capable of automating diagnostic analysis, patient monitoring, and administrative processes to improve healthcare delivery and patient outcomes. In some other implementations, the data processing system 300 may be configured to or otherwise capable of applying intelligent process allocation and real-time adaptation to optimize production lines, reduce waste, and enhance product quality. In some other implementations, the data processing system 300 may be configured to or otherwise capable of providing personalized learning paths, automated grading, and adaptive content delivery, which can revolutionize education and training.

In some CRM systems, managing customer interactions, tracking leads, and personalizing marketing efforts across various channels can be a complex process. Traditional CRM systems lack real-time adaptability and intelligent process allocation. In contrast, the data processing system 300 can intelligently allocate processes, such as lead scoring, customer segmentation, and personalized communication. By continuously monitoring performance and adapting to changes in customer behavior, the data processing system 300 ensures optimal resource allocation. Integration with human sales teams allows for seamless handoff of qualified leads. As such, the described techniques may promote enhanced lead conversion rates, personalized customer experiences, and improved efficiency in sales and marketing operations.

In some systems that support healthcare diagnostics automation, diagnosing medical conditions often involves analyzing vast amounts of data from various tests and medical records. Manual analysis is time-consuming and error prone. In accordance with the techniques described herein, the data processing system 300 can decompose diagnostic processes into sub-processes, such as data collection, preliminary analysis, and detailed examination. AI bots specialized in different medical domains can collaborate to provide accurate diagnoses. The data processing system 300 can also leverage continuous learning to ensure adaptation to new medical research and findings, thereby providing faster and more accurate diagnoses, reduced healthcare costs, and improved patient outcomes.

Managing a global supply chain typically involves complex processes like inventory management, routing, scheduling, and demand forecasting. Traditional methods of supply chain optimization lack real-time adaptability and efficiency. The techniques described herein generally provide for automating/optimizing various supply chain processes. Intelligent process decomposition ensures optimal allocation of resources, while real-time adaptation enables the data processing system 300 to respond to changes in demand, supply, or other constraints. The supply chain optimization techniques disclosed herein may reduce operational costs, minimize stockouts and/or overstocking, and enhance responsiveness to market changes.

Legal research involves sifting through vast amounts of legal documents, precedents, and regulations. This process can be time-intensive and often requires specialized expertise. The automated bot management techniques described herein can automate legal research by decomposing processes into sub-processes like keyword search, document retrieval, relevance scoring, and summarization. Specialized AI bots can collaborate with the data processing system 300 to provide comprehensive legal insights. Integration with human legal experts can help ensure quality control, thereby promoting reduced research time, cost savings, and enhanced legal insights for improved decision-making.

Managing energy distribution in a smart grid involves balancing supply and demand, optimizing energy flow, and ensuring fault tolerance. Traditional systems lack the flexibility and intelligence to manage these complex processes efficiently. The automated bot management techniques described herein can automate energy management processes by intelligently allocating resources based on real-time demand, supply, cost, and environmental constraints. Adaptive process decomposition enables the data processing system 300 to respond to changes in energy consumption patterns, weather conditions, or equipment failures, offering improved energy efficiency, reduced costs, enhanced reliability, and support for renewable energy integration.

The AI bot workflow diagram depicted in the example of FIG. 3 illustrates how AI bots (e.g., compute resources 240) can automate different aspects of business-to-business (B2B) sales via web crawling, email automation, phone calls, and task delegation. In accordance with one or more aspects of the present disclosure, a first set of compute resources 240 (e.g., web crawlers 1, 2, . . . n) may automatically gather valuable information on potential leads and relevant market data by searching various online sources. This process may include data collection, advanced search capabilities, real-time monitoring, and data enrichment. A second set of compute resources 240 (e.g., email automation bots 1, 2, . . . n) may automate the sending of personalized, targeted emails to prospects, handle initial outreach and follow-ups, and ultimately nurture leads through the sales funnel. This group of compute resources 240 may offer personalization, context-awareness, email scheduling/follow-ups, email tracking, and A/B testing capabilities. A third set of compute resources 240 (e.g., call automation bots 1, 2, . . . n) may automate and enhance phone-based communications with leads and prospects. These compute resources 240 may initiate, manage, and follow up on phone calls, and may also provide a personalized/engaging experience. This group of compute resources 240 may support call scheduling/dialing, conversation analysis, and post-call actions.

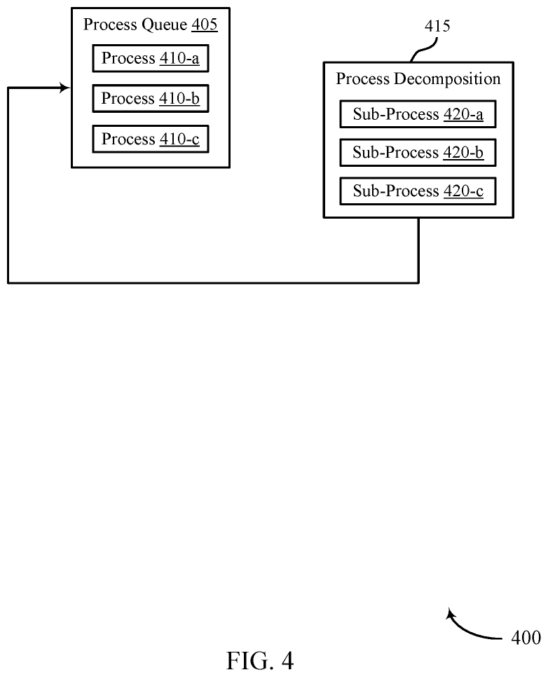

FIG. 4 shows an example of a process decomposition scheme 400 that supports autonomous execution of unstructured compute processes in accordance with aspects of the present disclosure. The process decomposition scheme 400 may be implemented by one or more components of the data processing systems shown and described with reference to FIGS. 1 through 3. For example, the process decomposition scheme 400 includes a process decomposition module 415 and a process queue 405 (e.g., a job queue), which may be supported by one or more components of the data processing system 100. The process queue 405 may contain a prioritized list of all unstructured processes 410 (e.g., jobs or tasks) to be completed by compute resources 240 (e.g., AI bots) of the data processing system 100.

The intelligent task management system depicted in the example of FIG. 1 may be configured to or otherwise capable of automatically and adaptively breaking down tasks based on complexity, available AI bots, and their respective capabilities. Unlike conventional methods, the techniques described herein may involve continuously monitoring AI bots' progress and overall task completion, adjusting decomposition and allocation in real-time to optimize performance. In the example of FIG. 4, the process queue 405 may include an unstructured process 410-a (e.g., Task A), an unstructured process 410-b (e.g., Task B), and an unstructured process 410-c (e.g., Task C), each of which may have a corresponding status (e.g., Waiting). The process decomposition module 415 may utilize an LLM to break unstructured processes 410 into parts based on the number and/or type of available bots/services (e.g., web crawler, data analysis, third-party service, email automation, call automation).

As an example, the process decomposition module 415 may decompose the unstructured process 410-a into a structured sub-process 420-a (e.g., Task A.1), a structured sub-process 420-b (e.g., Task A.2), and a structured sub-process 420-c (e.g., Task A.3). Accordingly, the process decomposition module 415 may assign dependencies and insert the structured sub-processes 420 back into the process queue 405. The structured sub-process 420-a may include a bot type (e.g., web crawler) and a status (e.g., assigned). The structured sub-process 420-b may include a bot type (e.g., data analysis) and a dependency (e.g., A.1). Likewise, the structured sub-process 420-c may include a bot type (e.g., call automation) and a dependency (e.g., A.2).

The process decomposition module 415 may be configured to break down tasks adaptively based on complexity and available resources. The process decomposition module 415 continuously monitors bot progress and overall task completion, adjusting decomposition and allocation in real-time to optimize performance. The input to the process decomposition module 415 includes the current state of tasks, bot progress, available resources, and any changes in constraints or conditions. The input may be structured to reflect the dynamic nature of the tasks and system (e.g., Task: “Analyze sales data”; Progress: Bot1 (50% complete); Available Resources: Bot3 (Visualization)).

The process decomposition module 415 processes the input by analyzing the current state, identifying opportunities for adaptive decomposition, and reallocating resources as needed. The process decomposition module 415 may leverage real-time data analytics and machine learning models for dynamic adaptation. The process decomposition module 415 may be configured to perform one or more of the following operations: monitor current state; identify opportunities for adaptation; reallocate resources. The output from the process decomposition module 415 may include updated task decomposition and allocation plans, reflecting real-time adjustments. The output may be structured to facilitate immediate execution and adaptation (e.g., Updated Plan: Sub-task1: “Analyze sales data”→Bot1; Sub-task2: “Visualize data”→Bot3).

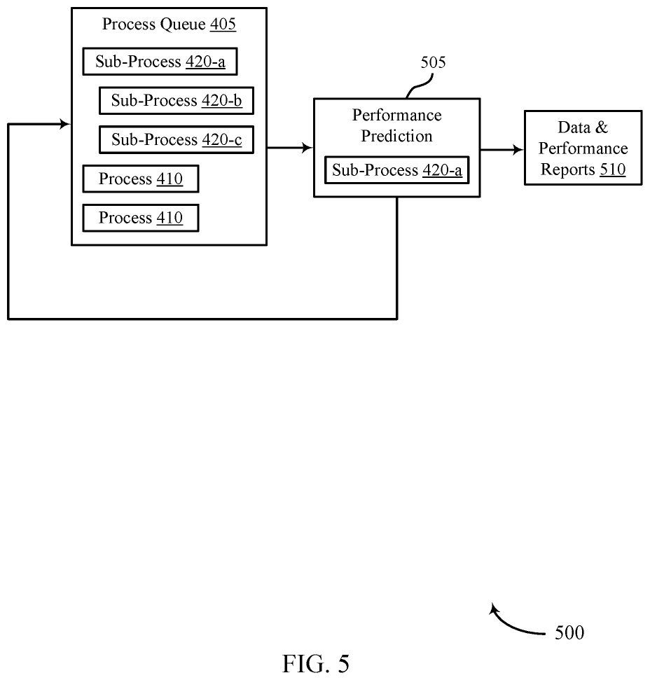

FIG. 5 shows an example of a performance prediction scheme 500 that supports autonomous execution of unstructured compute processes in accordance with aspects of the present disclosure. The performance prediction scheme 500 may be implemented by one or more components of the data processing systems shown and described with reference to FIGS. 1 through 3. For example, the performance prediction scheme 500 includes a performance prediction module 505, data and performance reports 510, and a process queue 405 (e.g., a job queue), which may be supported by one or more components of the data processing system 100. The process queue 405 may contain a prioritized list of unstructured processes 410 (e.g., jobs or tasks) and/or structured sub-processes 420 to be completed by compute resources 240 (e.g., AI bots) of the data processing system 100.

The bot performance prediction scheme depicted in the example of FIG. 5 may enable an automated bot management system (such as the data processing system 200 shown and described with reference to FIG. 2) to optimize the allocation of sub-tasks to AI bots by analyzing historical performance data, predicting the likelihood of success for a given task. As shown in the performance prediction scheme 500, the process queue 405 may include a structured sub-process 420-a (e.g., Task A.1), a structured sub-process 420-b (e.g., Task A.2), a structured sub-process 420-c (e.g., Task A.3), and one or more unstructured processes 410 (e.g., Task B and Task C). The structured sub-process 420-a may have an associated bot type (e.g., web crawler) and a status (e.g., decomposed). The structured sub-process 420-b may have an associated bot type (e.g., data analysis) and dependency (e.g., A.1). The structured sub-process 420-c may have an associated bot type (e.g., call automation) and dependency (e.g., A.2). The unstructured processes 410 may each have an associated status (e.g., waiting).

The bot performance prediction module 505 may be capable of or otherwise configured to assign each task to a resource allocation based on historical performance data, predicting the likelihood of success for a given task based on the operational constraints. For example, the performance prediction module 505 may predict the likelihood of a given compute resource 240 successfully completing the structured sub-process 420-a based on a set of operational constraints associated with the structured sub-process 420-a (e.g., limit runtime: 5 minutes; limit compute: 10,000 tokens). The data and performance reports 510 may include a store of historical performance and costs for a variety of task types, which the performance prediction module 505 may use to predict the likelihood of successful task completion.

The performance prediction module 505 (also referred to as a performance prediction engine) predicts bot performance for task allocation. The performance prediction module 505 analyzes historical data to predict the likelihood of success, robustness, and cost for a given task, enabling more informed and effective allocation decisions. The input to the performance prediction module 505 includes historical performance data of bots, task characteristics, and any relevant contextual information. The input may be structured to facilitate predictive modeling (e.g., Historical Data: Bot1 (90% success rate, average cost $50); Task: “Analyze sales data”).

The performance prediction module 505 processes the input by applying machine learning models (e.g., regression, classification) to predict bot performance for the given task. The performance prediction module 505 may leverage predictive analytics tools and machine learning frameworks like TensorFlow or PyTorch. The performance prediction module 505 may be configured to perform one or more of the following operations: pre-process historical data; train predictive model; predict performance for given task. The output from the performance prediction module 505 includes predicted performance metrics, such as success likelihood, expected cost, and robustness for the given task and bot. The output may be structured to guide task allocation decisions (e.g., Prediction: Bot1 for “Analyze sales data”→Success Likelihood: 90%, Expected Cost: $50).

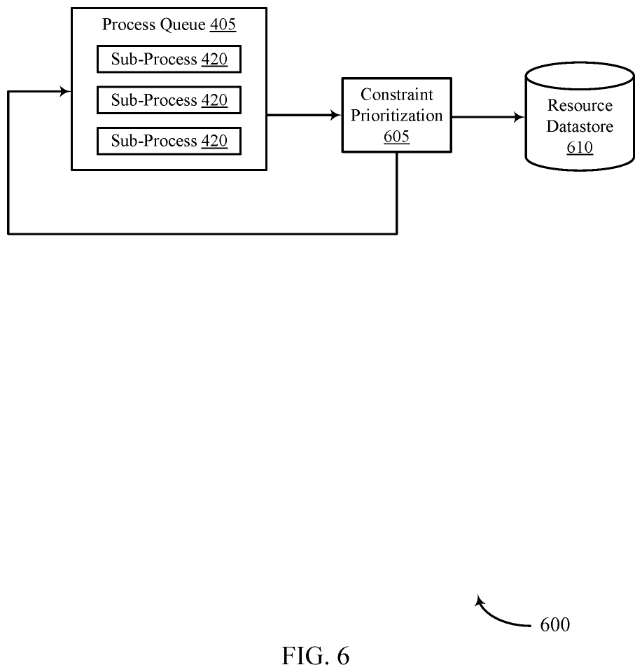

FIG. 6 shows an example of a constraint prioritization scheme 600 that supports autonomous execution of unstructured compute processes in accordance with aspects of the present disclosure. The constraint prioritization scheme 600 may be implemented by one or more components of the data processing systems shown and described with reference to FIGS. 1 through 3. For example, the performance prediction scheme 500 includes a performance prediction module 505, data and performance reports 510, and a process queue 405 (e.g., a job queue), which may be supported by one or more components of the data processing system 100. The process queue 405 may contain a prioritized list of unstructured processes 410 (e.g., jobs or tasks) and/or structured sub-processes 420 to be completed by compute resources 240 (e.g., AI bots) of the data processing system 100.

The constraint prioritization scheme 600 depicted in the example of FIG. 6 integrates multi-objective optimization, context-awareness, and predictive performance to efficiently allocate bot resources across a backlog of tasks. By continuously monitoring a project's status, adjusting task decomposition, and adapting to changes in operational constraints (such as cost, quality, and time), the automated bot management system can help ensure optimal task allocation.

Each of the structured sub-processes 420 in the process queue 405 may have a corresponding set of constraints/parameters. For example, a first structured sub-process 420 (e.g., Task M.3) may have a first set of operational constraints (type: web crawler; status: resource allocated; limit runtime: 5 minutes; limit compute: 10,000 tokens), a second structured sub-process 420 (e.g., Task L.2) may have a second set of operational constraints (type: web crawler; status: resource allocated; limit runtime: 5 minutes; limit compute: 10,000 tokens), and a third structured sub-process 420 (e.g., Task R.4) may have a third set of operational constraints (type: web crawler; status: resource allocated; limit runtime: 5 minutes; limit compute: 10,000 tokens).

The constraint prioritization module 605 may continuously evaluate the process queue 405, the task objectives, and the resource allocation(s) to maximally optimize the overall throughput of the process queue 405. The resource datastore 610 (e.g., resource inventory) may include a knowledge store that contains all information about compute resources 240, such as available bots and services, their compute availability, cost, uptime, longevity, performance, quality, etc.

The constraint prioritization module 605 manages constraint-based task allocation by integrating multi-objective optimization and context-awareness. The constraint prioritization module 605 efficiently allocates bot resources across tasks by continuously monitoring project status and adapting to changes in constraints like cost, quality, and time. The input to the constraint prioritization module 605 includes task definitions, constraints (cost, quality, time), current project status, and available resources. The input may be structured to reflect the multi-dimensional nature of the constraints and the dynamic context (e.g., Task: “Analyze sales data”; Constraints: Cost<$100, Quality>80%; Project Status: 50% complete).

The constraint prioritization module 605 processes the input by applying multi-objective optimization algorithms (e.g., Pareto optimization) and context-aware techniques to prioritize and satisfy constraints. In some examples, the constraint prioritization module 605 may employ optimization libraries and context-aware computing tools. The constraint prioritization module 605 may be configured to perform one or more of the following operations: analyze constraints; apply multi-objective optimization; adapt to context. The output from the constraint prioritization module 605 includes a prioritized and optimized task allocation plan that satisfies the given constraints, while adapting to the project's dynamic context. The output is structured to guide execution and ensure alignment with project goals (e.g., Optimized Plan: Sub-task1: “Analyze sales data”→Bot1; Cost: $80; Quality: 85%).

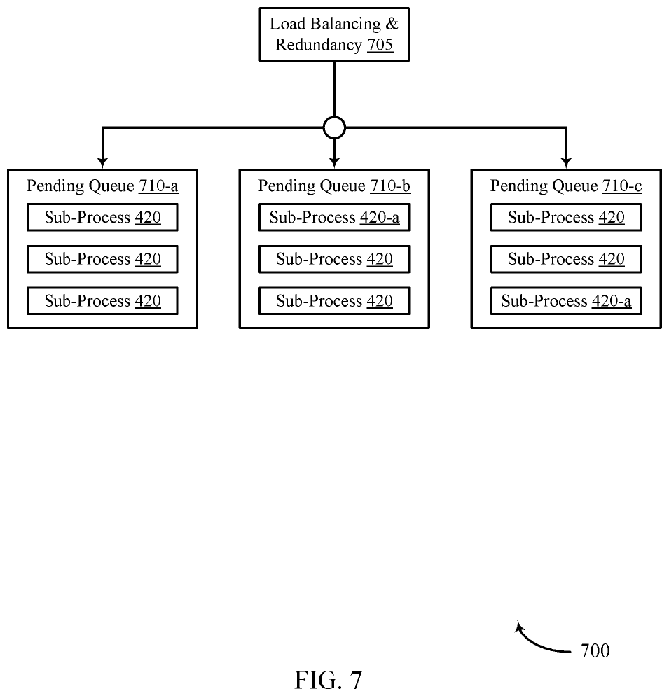

FIG. 7 shows an example of a load balancing and redundancy scheme 700 that supports autonomous execution of unstructured compute processes in accordance with aspects of the present disclosure. The load balancing and redundancy scheme 700 may be implemented by one or more components of the data processing systems shown and described with reference to FIGS. 1 through 3. For example, the load balancing and redundancy scheme 700 includes a load balancing and redundancy module 705 and pending queues 710 (e.g., bot queues), which may be supported by one or more components of the data processing system 100. Each of the pending queues 710 may contain a prioritized list of structured sub-processes 420 to be completed by a particular compute resource 240 (e.g., AI bot) of the data processing system 100.

In accordance with the load balancing and redundancy scheme 700 depicted in the example of FIG. 7, the load balancing and redundancy module 705 may dynamically balance workloads among AI bots, while ensuring redundancy to handle failures or performance drops. Key components include dynamic load balancing, health monitoring and fault detection, task redundancy and replication, automatic task reassignments, AI bot recovery and reintegration, and performance optimization/scaling. The load balancing and redundancy module 705 may monitor and update each of the pending queues 710.

In the example of FIG. 7, the pending queue 710-a (e.g., Bot Queue A.1) may include a first structured sub-process 420 (e.g., Task M.3) with a corresponding set of operational constraints (e.g., type: web crawler; status: resource allocated; limit runtime: 5 minutes; limit compute: 10,000 tokens), a second structured sub-process 420 (e.g., Task L.2) with a corresponding set of operational constraints (e.g., type: web crawler; status: resource allocated; limit runtime: 5 minutes; limit compute: 10,000 tokens), and a third structured sub-process 420 (e.g., Task R.4) with a corresponding set of operational constraints (e.g., type: web crawler; status: resource allocated; limit runtime: 5 minutes; limit compute: 10,000 tokens).

Likewise, the pending queue 710-b (e.g., Bot Queue A.2) may include a first structured sub-process 420-a (e.g., Task A.1) with a corresponding set of operational constraints (e.g., type: web crawler; status: resource allocated; limit runtime: 7 minutes; limit compute: 15,000 tokens), a second structured sub-process 420 (e.g., Task C.2) with a corresponding set of operational constraints (e.g., type: web crawler; status: resource allocated; limit runtime: 4 minutes; limit compute: 8,000 tokens), and a third structured sub-process 420 (e.g., Task M.3) with a corresponding set of operational constraints (e.g., type: web crawler; status: resource allocated; limit runtime: 5 minutes; limit compute: 10,000 tokens).

Similarly, the pending queue 710-c (e.g., Bot Queue A.3) may include a first structured sub-process 420 (e.g., Task R.4) with a corresponding set of operational constraints (e.g., type: web crawler; status: resource allocated; limit runtime: 5 minutes; limit compute: 10,000 tokens), a second structured sub-process 420 (e.g., Task B.1) with a corresponding set of operational constraints (e.g., type: web crawler; status: resource allocated; limit runtime: 8 minutes; limit compute: 10,000 tokens), and a third structured sub-process 420-a (e.g., Task A.1) with a corresponding set of operational constraints (e.g., type: web crawler; status: resource allocated; limit runtime: 7 minutes; limit compute: 15,000 tokens). The load balancing and redundancy module 705 may assign multiple instances of the same structured sub-process 420-a to different compute resources 240 to account for errors, failures, delays, etc.

The load balancing and redundancy module 705 may be responsible for dynamically balancing workloads among AI bots while ensuring redundancy to handle failures or performance drops. The load balancing and redundancy module 705 may support dynamic load balancing, fault detection, task redundancy, automatic reassignment, and/or performance optimization.

The input to the load balancing and redundancy module 705 may include current workloads, bot statuses (e.g., health, availability), task requirements, and system performance metrics. The input may be structured to reflect the dynamic nature of workloads and system conditions (e.g., Workloads: Bot1 (70% capacity), Bot2 (30% capacity); Task: “Visualize data”). The load balancing and redundancy module 705 may process the input by applying load balancing algorithms (e.g., Round Robin, Least Connections) and redundancy mechanisms to distribute workloads evenly and ensure fault tolerance. The load balancing and redundancy module 705 may leverage distributed computing tools and real-time monitoring systems.

The load balancing and redundancy module 705 may be configured to perform one or more of the following operations: monitor workloads; apply load balancing; implement redundancy; optimize performance. The output from the load balancing and redundancy module 705 may include a balanced workload distribution plan, redundancy measures, and performance optimization actions. The output may be structured to ensure smooth execution and robustness (e.g., Balanced Plan: Sub-task1: “Visualize data”→Bot1 (30%); Sub-task2: “Visualize data”→Bot2 (30%)).

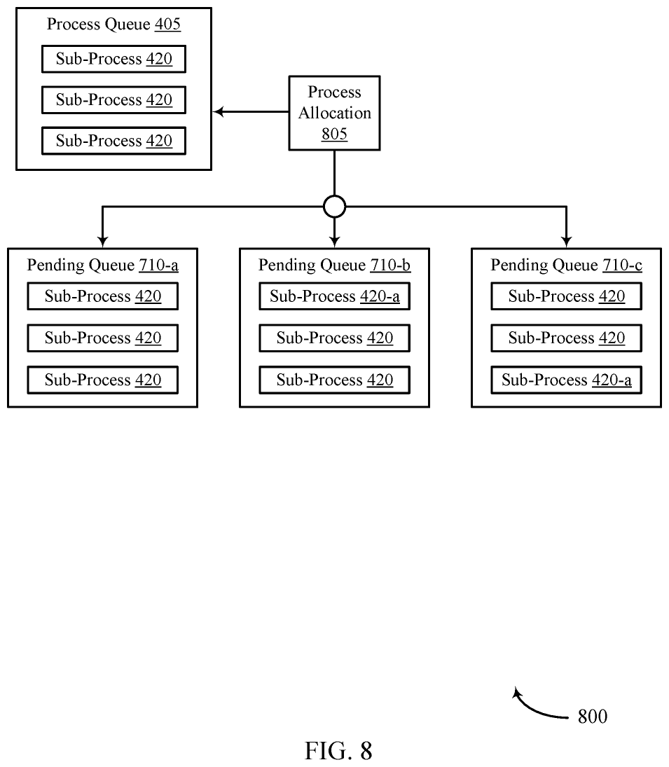

FIG. 8 shows an example of a process allocation scheme 800 that supports autonomous execution of unstructured compute processes in accordance with aspects of the present disclosure. The process allocation scheme 800 may be implemented by one or more components of the data processing systems shown and described with reference to FIGS. 1 through 3. For example, the process allocation scheme 800 includes a process allocation module 805, a process queue 405 (e.g., job queue), and pending queues 710 (e.g., bot queues), which may be supported by one or more components of the data processing system 100. Each of the pending queues 710 may contain a prioritized list of structured sub-processes 420 to be completed by a particular compute resource 240 (e.g., AI bot) of the data processing system 100.

In accordance with the process allocation scheme 800 depicted in the example of FIG. 8, an autonomous bot management system (such as the data processing system 200 shown and described with reference to FIG. 2) may distribute tasks among AI bots. A process allocation module 805 of the autonomous bot management system may consider operational constraints (such as cost, quality, and time) and continuously monitor bot performance, making real-time adjustments to the number of bots as needed. In particular, the process allocation module 805 may analyze jobs in the process queue 405 and assign them to pending queues 710 (e.g., available Bot Queues) based on their status, priority, resource allocation, and other attributes. The process allocation module 805 may also support collaboration between multiple bots, enabling them to utilize each other's capabilities.

In the example of FIG. 8, the pending queue 710-a (e.g., Bot Queue A.1) may include a first structured sub-process 420 (e.g., Task M.3) with a corresponding set of operational constraints (e.g., type: web crawler; status: resource allocated; limit runtime: 5 minutes; limit compute: 10,000 tokens), a second structured sub-process 420 (e.g., Task L.2) with a corresponding set of operational constraints (e.g., type: web crawler; status: resource allocated; limit runtime: 5 minutes; limit compute: 10,000 tokens), and a third structured sub-process 420 (e.g., Task R.4) with a corresponding set of operational constraints (e.g., type: web crawler; status: resource allocated; limit runtime: 5 minutes; limit compute: 10,000 tokens).

Likewise, the pending queue 710-b (e.g., Bot Queue A.2) may include a first structured sub-process 420-a (e.g., Task A.1) with a corresponding set of operational constraints (e.g., type: web crawler; status: resource allocated; limit runtime: 7 minutes; limit compute: 15,000 tokens), a second structured sub-process 420 (e.g., Task C.2) with a corresponding set of operational constraints (e.g., type: web crawler; status: resource allocated; limit runtime: 4 minutes; limit compute: 8,000 tokens), and a third structured sub-process 420 (e.g., Task M.3) with a corresponding set of operational constraints (e.g., type: web crawler; status: resource allocated; limit runtime: 5 minutes; limit compute: 10,000 tokens).

Similarly, the pending queue 710-c (e.g., Bot Queue A.3) may include a first structured sub-process 420 (e.g., Task R.4) with a corresponding set of operational constraints (e.g., type: web crawler; status: resource allocated; limit runtime: 5 minutes; limit compute: 10,000 tokens), a second structured sub-process 420 (e.g., Task B.1) with a corresponding set of operational constraints (e.g., type: web crawler; status: resource allocated; limit runtime: 8 minutes; limit compute: 10,000 tokens), and a third structured sub-process 420-a (e.g., Task A.1) with a corresponding set of operational constraints (e.g., type: web crawler; status: resource allocated; limit runtime: 7 minutes; limit compute: 15,000 tokens). The load balancing and redundancy module 705 may assign multiple instances of the same structured sub-process 420-a to different compute resources 240 to account for errors, failures, delays, etc.

The process allocation module 805 (also referred to as the task allocation engine) is responsible for distributing tasks among AI bots. The process allocation module 805 utilizes optimization algorithms and constraint satisfaction to allocate tasks based on factors like cost, quality, time, and bot capabilities. The process allocation module 805 enhances efficiency by dynamically assigning tasks to multiple bots. The input to the process allocation module 805 includes high-level task definitions, constraints (such as cost, time, quality), available AI bots, and their capabilities. The input may be structured to define the task's complexity, requirements, and available resources (e.g., Task: “Analyze sales data”; Constraints: Cost<$100, Time<2 hours; Available Bots: Bot1 (Data Analysis), Bot2 (Visualization)).

The process allocation module 805 processes the input by applying optimization algorithms (e.g., linear programming) and constraint satisfaction techniques to decompose the task and allocate sub-tasks to suitable bots. The process allocation module 805 may utilize machine learning models to predict bot performance and optimization libraries for constraint handling. The process allocation module 805 may be configured to perform one or more of the following operations: analyze task complexity; decompose into sub-tasks; apply constraints; allocate sub-tasks to bots. The output from the process allocation module 805 includes a detailed allocation plan, defining the sub-tasks, assigned bots, expected cost, quality, and time. The output is structured to facilitate execution and monitoring (e.g., Sub-task1: “Analyze sales data”→Bot1; Sub-task2: “Visualize data”→Bot2; Cost: $80; Time: 1.5 hours).

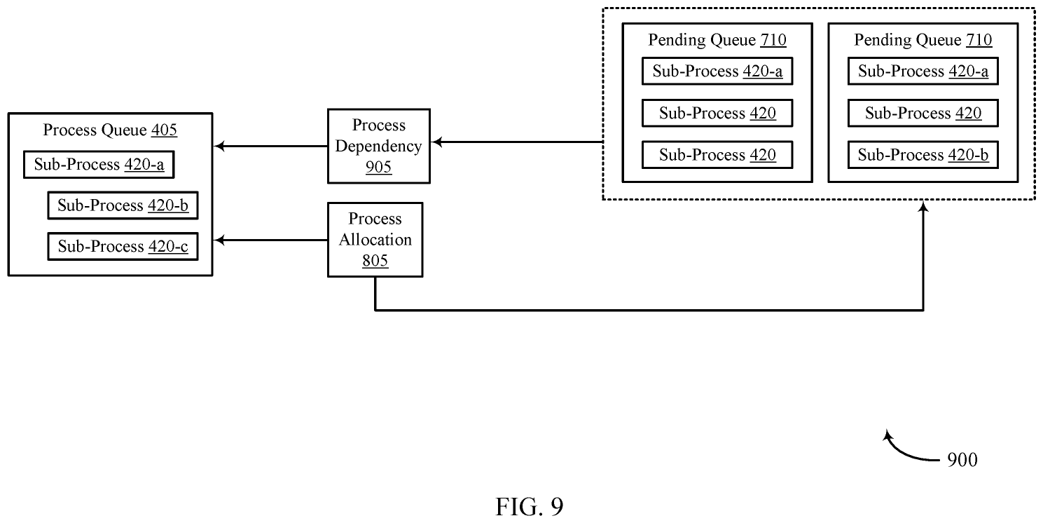

FIG. 9 shows an example of a dependency management scheme 900 that supports autonomous execution of unstructured compute processes in accordance with aspects of the present disclosure. The dependency management scheme 900 may be implemented by one or more components of the data processing systems shown and described with reference to FIGS. 1 through 3. For example, the dependency management scheme 900 includes a process allocation module 805, a process dependency module 905, a process queue 405 (e.g., job queue), and pending queues 710 (e.g., bot queues), which may be supported by one or more components of the data processing system 100. Each of the pending queues 710 may contain a prioritized list of structured sub-processes 420 to be completed by a particular compute resource 240 (e.g., AI bot) of the data processing system 100.

The dependency management scheme 900 depicted in the example of FIG. 9 may enable an automated bot management system (such as the data processing system 200 shown and described with reference to FIG. 2) to manage complex task dependencies by employing a task dependency graph, task scheduler, priority queue, resource allocator, task monitor, and/or feedback loop, thereby ensuring that tasks are executed in the correct order using the optimal resource allocation. The integration with AI bots enables automation of specific tasks, enhancing efficiency and freeing human resources for strategic roles. A continuous feedback loop allows for ongoing improvements in scheduling and/or resource allocation.

In the example of FIG. 9, a first pending queue 710 (e.g., Bot Queue) may include a first structured sub-process 420-a (e.g., Task A.1) with a corresponding set of operational constraints (e.g., type: web crawler; status: complete; limit runtime: 5 minutes; limit compute: 10,000 tokens), a second structured sub-process 420 (e.g., Task L.2) with a corresponding set of operational constraints (e.g., type: web crawler; status: ready; limit runtime: 5 minutes; limit compute: 10,000 tokens), and a third structured sub-process 420 (e.g., Task R.4) with a corresponding set of operational constraints (e.g., type: web crawler; status: ready; limit runtime: 5 minutes; limit compute: 10,000 tokens).

Likewise, a second pending queue 710 (e.g., Bot Queue) may include a first structured sub-process 420-a (e.g., Task A.1) with a corresponding set of operational constraints (e.g., type: data analysis; status: running; limit runtime: 5 minutes; limit compute: 10,000 tokens), a second structured sub-process 420 (e.g., Task L.2) with a corresponding set of operational constraints (e.g., type: data analysis; status: resource allocated; limit runtime: 5 minutes; limit compute: 10,000 tokens), and a third structured sub-process 420-b (e.g., Task A.2) with a corresponding set of operational constraints (e.g., type: data analysis; status: ready; limit runtime: 5 minutes; limit compute: 10,000 tokens).

The process allocation module 805 may be configured to analyze jobs in the process queue 405 and assign them to available bot queues (e.g., pending queues 710) based on their status, priority, resource allocation, and other attributes. The process queue 405 (e.g., Job Queue) may include a first structured sub-process 420-a (e.g., Task A.1) with a corresponding set of operational constraints (e.g., type: web crawler; status: complete; limit runtime: 5 minutes; limit compute: 10,000 tokens), a second structured sub-process 420-b (e.g., Task A.2) with a corresponding set of operational constraints (e.g., type: data analysis; dependency: A.1; status: resource allocated; limit runtime: 5 minutes; limit compute: 10,000 tokens), and a third structured sub-process 420-c (e.g., Task A.3) with a corresponding set of operational constraints (e.g., type: automation; dependency: A.2; status: resource allocated; limit runtime: 5 minutes; limit compute: 10,000 tokens).

The process dependency module 905 may be configured to manage a task dependencies graph to ensure that jobs are completed in an orderly, optimal manner. The process dependency module 905 may be further configured to evaluate task completeness and ensure that tasks are completed in full. The process dependency module 905 may be further configured to evaluate against an objective to determine if an overall task should be canceled or continued. The process dependency module 905 may be further configured to ready dependent tasks, for example, by updating dependent tasks and readying them to be allocated.

The process dependency module 905 manages complex task dependencies by employing a task dependency graph, scheduler, priority queue, resource allocator, task monitor, and feedback loop. The process dependency module 905 ensures tasks are executed in the correct order and resources are allocated optimally. The input to the process dependency module 905 includes task definitions, dependencies, priorities, available resources, and current system status. The input must be structured to represent the complex interdependencies and requirements of the tasks (e.g., Task1: “Collect data”; Task2: “Analyze data” (depends on Task1); Priority: Task2>Task1). The process dependency module 905 may process the input by constructing a task dependency graph, scheduling tasks based on dependencies and priorities, allocating resources, and monitoring execution. The process dependency module 905 may leverage one or more graph algorithms, scheduling libraries, and real-time monitoring tools.

The process dependency module 905 may be configured to perform the following operations: construct dependency graph; schedule tasks; allocate resources; monitor execution. The output of the process dependency module 905 may include a detailed execution plan that respects task dependencies, priorities, and resource constraints. The output may be structured to guide execution and ensure alignment with task requirements (e.g., Execution Plan: Task1: “Collect data”→Bot1; Task2: “Analyze data”→Bot2).

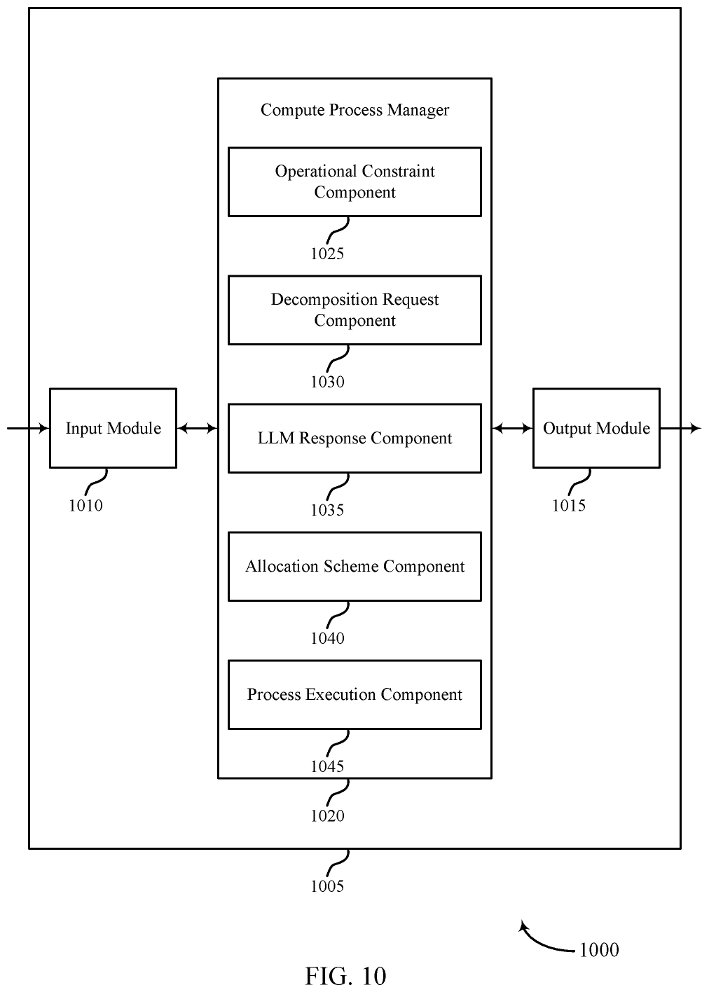

FIG. 10 shows a block diagram 1000 of a device 1005 that supports autonomous execution of unstructured compute processes in accordance with aspects of the present disclosure. The device 1005 may include an input module 1010, an output module 1015, and a compute process manager 1020. The device 1005, or one of more components of the device 1005 (e.g., the input module 1010, the output module 1015, and the compute process manager 1020), may include at least one processor, which may be coupled with at least one memory, to support the described techniques. Each of these components may be in communication with one another (e.g., via one or more buses).

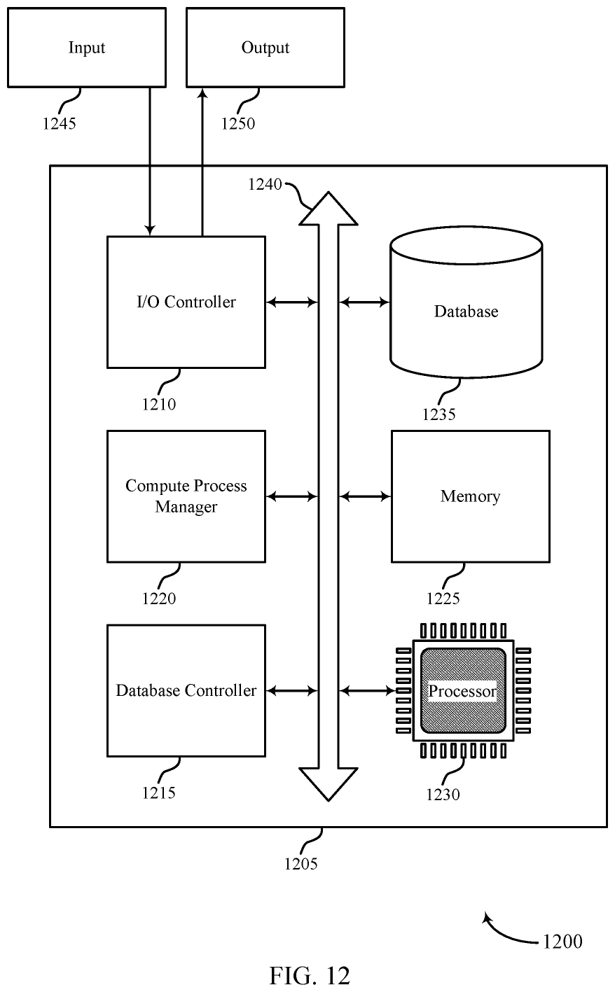

The input module 1010 may manage input signals for the device 1005. For example, the input module 1010 may identify input signals based on an interaction with a modem, a keyboard, a mouse, a touchscreen, or a similar device. These input signals may be associated with user input or processing at other components or devices. In some cases, the input module 1010 may utilize an operating system such as iOS®, ANDROID®, MS-DOS®, MS-WINDOWS®, OS/2®, UNIX®, LINUX®, or another known operating system to handle input signals. The input module 1010 may send aspects of these input signals to other components of the device 1005 for processing. For example, the input module 1010 may transmit input signals to the compute process manager 1020 to support autonomous execution of unstructured compute processes. In some cases, the input module 1010 may be a component of an input/output (I/O) controller 1210, as described with reference to FIG. 12.

The output module 1015 may manage output signals for the device 1005. For example, the output module 1015 may receive signals from other components of the device 1005, such as the compute process manager 1020, and may transmit these signals to other components or devices. In some examples, the output module 1015 may transmit output signals for display in a user interface, for storage in a database or data store, for further processing at a server or server cluster, or for any other processes at any number of devices or systems. In some cases, the output module 1015 may be a component of an I/O controller 1210, as described with reference to FIG. 12.

For example, the compute process manager 1020 may include an operational constraint component 1025, a decomposition request component 1030, an LLM response component 1035, an allocation scheme component 1040, a process execution component 1045, or any combination thereof. In some examples, the compute process manager 1020, or various components thereof, may be configured to perform various operations (e.g., receiving, monitoring, transmitting) using or otherwise in cooperation with the input module 1010, the output module 1015, or both. For example, the compute process manager 1020 may receive information from the input module 1010, send information to the output module 1015, or be integrated in combination with the input module 1010, the output module 1015, or both to receive information, transmit information, or perform various other operations as described herein.

The operational constraint component 1025 may be configured to support receiving, by a data processing system, an indication of one or more operational constraints for an unstructured compute process to be executed by the data processing system. The decomposition request component 1030 may be configured to support transmitting, to a LLM that is configured to communicate with the data processing system, a request to decompose the unstructured compute process into a set of structured sub-processes and allocate the set of structured sub-processes to a set of compute resources of the data processing system in accordance with the one or more operational constraints. The LLM response component 1035 may be configured to support receiving, from the LLM, a response including information associated with an allocation scheme for the set of structured sub-processes of the unstructured compute process. The allocation scheme component 1040 may be configured to support allocating, by the data processing system, the set of structured sub-processes identified by the LLM to the set of compute resources of the data processing system in accordance with the allocation scheme and the one or more operational constraints. The process execution component 1045 may be configured to support executing, by the set of compute resources of the data processing system, the set of structured sub-processes based on using the LLM to retrieve data from a set of data sources in accordance with the one or more operational constraints.

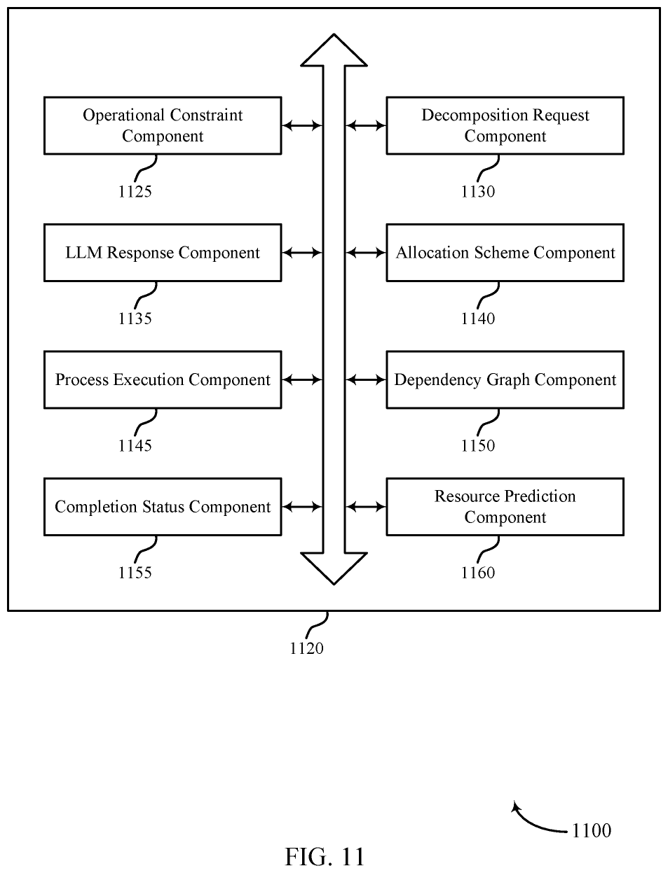

FIG. 11 shows a block diagram 1100 of a compute process manager 1120 that supports autonomous execution of unstructured compute processes in accordance with aspects of the present disclosure. The compute process manager 1120 may be an example of aspects of a compute process manager or a compute process manager 1020, or both, as described herein. The compute process manager 1120, or various components thereof, may be an example of means for performing various aspects of autonomous execution of unstructured compute processes as described herein. For example, the compute process manager 1120 may include an operational constraint component 1125, a decomposition request component 1130, an LLM response component 1135, an allocation scheme component 1140, a process execution component 1145, a dependency graph component 1150, a completion status component 1155, a resource prediction component 1160, or any combination thereof. Each of these components, or components of subcomponents thereof (e.g., one or more processors, one or more memories), may communicate, directly or indirectly, with one another (e.g., via one or more buses).

The operational constraint component 1125 may be configured to support receiving, by a data processing system, an indication of one or more operational constraints for an unstructured compute process to be executed by the data processing system. The decomposition request component 1130 may be configured to support transmitting, to a LLM that is configured to communicate with the data processing system, a request to decompose the unstructured compute process into a set of structured sub-processes and allocate the set of structured sub-processes to a set of compute resources of the data processing system in accordance with the one or more operational constraints. The LLM response component 1135 may be configured to support receiving, from the LLM, a response including information associated with an allocation scheme for the set of structured sub-processes of the unstructured compute process. The allocation scheme component 1140 may be configured to support allocating, by the data processing system, the set of structured sub-processes identified by the LLM to the set of compute resources of the data processing system in accordance with the allocation scheme and the one or more operational constraints. The process execution component 1145 may be configured to support executing, by the set of compute resources of the data processing system, the set of structured sub-processes based on using the LLM to retrieve data from a set of data sources in accordance with the one or more operational constraints.

In some examples, to support allocating the set of structured sub-processes, the allocation scheme component 1140 may be configured to support dynamically adjusting a quantity of the set of compute resources to which the set of structured sub-processes are allocated based on performance data associated with the set of structured sub-processes.

In some examples, the decomposition request component 1130 may be configured to support decomposing the unstructured compute process into the set of structured sub-processes based on a complexity of the unstructured compute process, a quantity of compute resources available to execute the unstructured compute process, and respective processing capabilities of the available compute resources.

In some examples, to support allocating the set of structured sub-processes to the set of compute resources, the allocation scheme component 1140 may be configured to support allocating at least one structured compute sub-process to a first compute resource of the set of compute resources based on a likelihood of the first compute resource successfully completing the at least one structured compute sub-process.

In some examples, the allocation scheme component 1140 may be configured to support re-allocating at least one structured sub-process from a first compute resource to a second compute resource based on a change to the one or more operational constraints for the unstructured compute process.

In some examples, the allocation scheme component 1140 may be configured to support allocating multiple instances of a structured sub-process to different compute resources of the data processing system to support failure recovery and fault tolerance.

In some examples, the dependency graph component 1150 may be configured to support generating a process dependency graph that contains information associated with the set of structured sub-processes and the set of compute resources to which the set of structured sub-processes are allocated.

In some examples, the allocation scheme component 1140 may be configured to support updating the allocation scheme for the set of structured sub-processes of the unstructured compute process based on feedback information provided by the set of compute resources.

In some examples, the set of structured sub-processes include searching one or more online data sources, searching one or more databases, or interacting with one or more third-party systems. In some examples, the set of compute resources include a network of AI bots that are capable of executing the set of structured sub-processes.

In some examples, the one or more operational constraints include a time constraint for the unstructured compute process, a quality constraint for the unstructured compute process, a processing cost constraint for the unstructured compute process, a resource capability constraint for the unstructured compute process, or any combination thereof.

In some examples, the allocation scheme identifies the set of structured sub-processes into which the unstructured compute process is to be decomposed, the set of compute resources to which the set of structured sub-processes are to be assigned, and a projected set of operational constraints for the unstructured compute process.

In some examples, the completion status component 1155 may be configured to support monitoring a completion status of one or more ongoing structured sub-processes, where allocating the set of structured sub-processes to the set of compute resources is based on the completion status.

In some examples, the resource prediction component 1160 may be configured to support using a machine learning model to predict a likelihood of a first compute resource successfully completing a first structured sub-process, where the machine learning model is trained on historic performance data associated with the first compute resource. In some examples, the allocation scheme component 1140 may be configured to support allocating the first structured sub-process to the first compute resource if the likelihood is above a threshold.

In some examples, the process execution component 1145 may be configured to support detecting a failure or performance issue associated with execution of at least one structured sub-process of the set of structured sub-processes. In some examples, the allocation scheme component 1140 may be configured to support dynamically re-allocating the at least one structured sub-process to another compute resource based on the failure or performance issue.

In some examples, the allocation scheme is developed using a generative AI model of the LLM. In some examples, the one or more operational constraints are provided by a user of the data processing system. In some examples, the one or more operational constraints are identified by the LLM.

FIG. 12 shows a diagram of a system 1200 including a device 1205 that supports autonomous execution of unstructured compute processes in accordance with aspects of the present disclosure. The device 1205 may be an example of or include the components of a device 1005 as described herein. The device 1205 may include components for bi-directional data communications including components for transmitting and receiving communications, such as a compute process manager 1220, an I/O controller 1210, a database controller 1215, at least one memory 1225, at least one processor 1230, and a database 1235. These components may be in electronic communication or otherwise coupled (e.g., operatively, communicatively, functionally, electronically, electrically) via one or more buses (e.g., a bus 1240).

The I/O controller 1210 may manage input signals 1245 and output signals 1250 for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. In other cases, the I/O controller 1210 may represent or interact with a modem, a keyboard, a mouse, a touchscreen, or a similar device. In some cases, the I/O controller 1210 may be implemented as part of a processor 1230. In some examples, a user may interact with the device 1205 via the I/O controller 1210 or via hardware components controlled by the I/O controller 1210.

The database controller 1215 may manage data storage and processing in a database 1235. In some cases, a user may interact with the database controller 1215. In other cases, the database controller 1215 may operate automatically without user interaction. The database 1235 may be an example of a single database, a distributed database, multiple distributed databases, a data store, a data lake, or an emergency backup database.

Memory 1225 may include random-access memory (RAM) and read-only memory (ROM). The memory 1225 may store computer-readable, computer-executable software including instructions that, when executed, cause at least one processor 1230 to perform various functions described herein. In some cases, the memory 1225 may contain, among other things, a basic I/O system (BIOS) which may control basic hardware or software operation such as the interaction with peripheral components or devices. The memory 1225 may be an example of a single memory or multiple memories. For example, the device 1205 may include one or more memories 1225.

The processor 1230 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 1230 may be configured to operate a memory array using a memory controller. In other cases, a memory controller may be integrated into the processor 1230. The processor 1230 may be configured to execute computer-readable instructions stored in at least one memory 1225 to perform various functions (e.g., functions or tasks supporting autonomous execution of unstructured compute processes). The processor 1230 may be an example of a single processor or multiple processors. For example, the device 1205 may include one or more processors 1230.

For example, the compute process manager 1220 may be configured to support receiving, by a data processing system, an indication of one or more operational constraints for an unstructured compute process to be executed by the data processing system. The compute process manager 1220 may be configured to support transmitting, to a LLM that is configured to communicate with the data processing system, a request to decompose the unstructured compute process into a set of structured sub-processes and allocate the set of structured sub-processes to a set of compute resources of the data processing system in accordance with the one or more operational constraints. The compute process manager 1220 may be configured to support receiving, from the LLM, a response including information associated with an allocation scheme for the set of structured sub-processes of the unstructured compute process. The compute process manager 1220 may be configured to support allocating, by the data processing system, the set of structured sub-processes identified by the LLM to the set of compute resources of the data processing system in accordance with the allocation scheme and the one or more operational constraints. The compute process manager 1220 may be configured to support executing, by the set of compute resources of the data processing system, the set of structured sub-processes based on using the LLM to retrieve data from a set of data sources in accordance with the one or more operational constraints.

By including or configuring the compute process manager 1220 in accordance with examples as described herein, the device 1205 may support techniques for reduced latency and improved user experience related to reduced processing and improved coordination between resources.

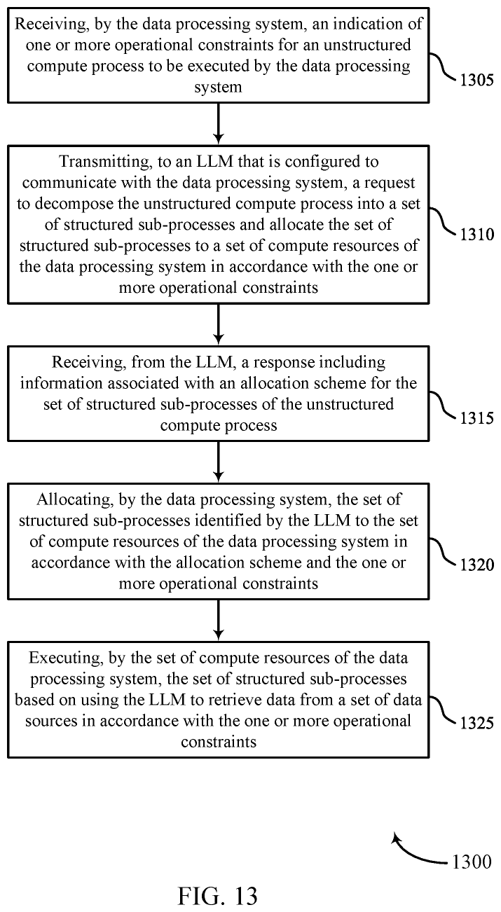

FIG. 13 shows a flowchart illustrating a method 1300 that supports autonomous execution of unstructured compute processes in accordance with aspects of the present disclosure. Operations of the method 1300 may be implemented by a data processing system, such as the data processing system 200 shown and described with reference to FIG. 2. In some examples, the data processing system may execute a set of instructions to control the functional elements of the data processing system to perform the described functions. Additionally, or alternatively, the data processing system may perform aspects of the described functions using special-purpose hardware.

At 1305, the method may include receiving, by the data processing system, an indication of one or more operational constraints for an unstructured compute process to be executed by the data processing system. In some examples, aspects of the operations of 1305 may be performed by an operational constraint component 1125, as described with reference to FIG. 11.

At 1310, the method may include transmitting, to an LLM that is configured to communicate with the data processing system, a request to decompose the unstructured compute process into a set of structured sub-processes and allocate the set of structured sub-processes to a set of compute resources of the data processing system in accordance with the one or more operational constraints. In some examples, aspects of the operations of 1310 may be performed by a decomposition request component 1130, as described with reference to FIG. 11.

At 1315, the method may include receiving, from the LLM, a response including information associated with an allocation scheme for the set of structured sub-processes of the unstructured compute process. In some examples, aspects of the operations of 1315 may be performed by an LLM response component 1135, as described with reference to FIG. 11.

At 1320, the method may include allocating, by the data processing system, the set of structured sub-processes identified by the LLM to the set of compute resources of the data processing system in accordance with the allocation scheme and the one or more operational constraints. In some examples, aspects of the operations of 1320 may be performed by an allocation scheme component 1140, as described with reference to FIG. 11.

At 1325, the method may include executing, by the set of compute resources of the data processing system, the set of structured sub-processes based on using the LLM to retrieve data from a set of data sources in accordance with the one or more operational constraints. In some examples, aspects of the operations of 1325 may be performed by a process execution component 1145, as described with reference to FIG. 11.

A method is described. The method may include: receiving, by a data processing system, an indication of one or more operational constraints for an unstructured compute process to be executed by the data processing system; transmitting, to a LLM that is configured to communicate with the data processing system, a request to decompose the unstructured compute process into a set of structured sub-processes and allocate the set of structured sub-processes to a set of compute resources of the data processing system in accordance with the one or more operational constraints; receiving, from the LLM, a response including information associated with an allocation scheme for the set of structured sub-processes of the unstructured compute process; allocating, by the data processing system, the set of structured sub-processes identified by the LLM to the set of compute resources of the data processing system in accordance with the allocation scheme and the one or more operational constraints; and executing, by the set of compute resources of the data processing system, the set of structured sub-processes based on using the LLM to retrieve data from a set of data sources in accordance with the one or more operational constraints.

An apparatus is described. The apparatus may include at least one memory storing code for data processing, and one or more processors coupled with the at least one memory. The one or more processors may be individually or collectively operable to execute the code to cause the apparatus to: receive, by a data processing system, an indication of one or more operational constraints for an unstructured compute process to be executed by the data processing system; transmit, to a LLM that is configured to communicate with the data processing system, a request to decompose the unstructured compute process into a set of structured sub-processes and allocate the set of structured sub-processes to a set of compute resources of the data processing system in accordance with the one or more operational constraints; receive, from the LLM, a response including information associated with an allocation scheme for the set of structured sub-processes of the unstructured compute process; allocate, by the data processing system, the set of structured sub-processes identified by the LLM to the set of compute resources of the data processing system in accordance with the allocation scheme and the one or more operational constraints; and execute, by the set of compute resources of the data processing system, the set of structured sub-processes based on using the LLM to retrieve data from a set of data sources in accordance with the one or more operational constraints.

A non-transitory computer-readable medium is described. The non-transitory computer-readable medium may store code that includes instructions executable by one or more processors to: receive, by a data processing system, an indication of one or more operational constraints for an unstructured compute process to be executed by the data processing system; transmit, to a LLM that is configured to communicate with the data processing system, a request to decompose the unstructured compute process into a set of structured sub-processes and allocate the set of structured sub-processes to a set of compute resources of the data processing system in accordance with the one or more operational constraints; receive, from the LLM, a response including information associated with an allocation scheme for the set of structured sub-processes of the unstructured compute process; allocate, by the data processing system, the set of structured sub-processes identified by the LLM to the set of compute resources of the data processing system in accordance with the allocation scheme and the one or more operational constraints; and execute, by the set of compute resources of the data processing system, the set of structured sub-processes based on using the LLM to retrieve data from a set of data sources in accordance with the one or more operational constraints.

In some examples described herein, allocating the set of structured sub-processes may include operations, features, means, or instructions for dynamically adjusting a quantity of the set of compute resources to which the set of structured sub-processes is allocated based on performance data associated with the set of structured sub-processes.

Some examples described herein may further include operations, features, means, or instructions for decomposing the unstructured compute process into the set of structured sub-processes based on a complexity of the unstructured compute process, a quantity of compute resources available to execute the unstructured compute process, and respective processing capabilities of the available compute resources.

In some examples described herein, allocating the set of structured sub-processes to the set of compute resources may include operations, features, means, or instructions for allocating at least one structured compute sub-process to a first compute resource of the set of compute resources based on a likelihood of the first compute resource successfully completing the at least one structured compute sub-process.

Some examples described herein may further include operations, features, means, or instructions for re-allocating at least one structured sub-process from a first compute resource to a second compute resource based on a change to the one or more operational constraints for the unstructured compute process.

Some examples described herein may further include operations, features, means, or instructions for allocating multiple instances of a structured sub-process to different compute resources of the data processing system to support failure recovery and fault tolerance.

Some examples described herein may further include operations, features, means, or instructions for generating a process dependency graph that contains information associated with the set of structured sub-processes and the set of compute resources to which the set of structured sub-processes are allocated.

Some examples described herein may further include operations, features, means, or instructions for updating the allocation scheme for the set of structured sub-processes of the unstructured compute process based on feedback information provided by the set of compute resources.

In some examples described herein, the set of structured sub-processes include searching one or more online data sources, searching one or more databases, or interacting with one or more third-party systems.

In some examples described herein, the set of compute resources include a network of AI bots that are capable of executing the set of structured sub-processes.

In some examples described herein, the one or more operational constraints include a time constraint for the unstructured compute process, a quality constraint for the unstructured compute process, a processing cost constraint for the unstructured compute process, a resource capability constraint for the unstructured compute process, or any combination thereof.

In some examples described herein, the allocation scheme identifies the set of structured sub-processes into which the unstructured compute process is to be decomposed, the set of compute resources to which the set of structured sub-processes is to be assigned, and a projected set of operational constraints for the unstructured compute process.

Some examples described herein may further include operations, features, means, or instructions for monitoring a completion status of one or more ongoing structured sub-processes, where allocating the set of structured sub-processes to the set of compute resources is based on the completion status.

Some examples described herein may further include operations, features, means, or instructions for using a machine learning model to predict a likelihood of a first compute resource successfully completing a first structured sub-process, where the machine learning model is trained on historic performance data associated with the first compute resource and allocating the first structured sub-process to the first compute resource if the likelihood is above a threshold.

Some examples described herein may further include operations, features, means, or instructions for detecting a failure or performance issue associated with execution of at least one structured sub-process of the set of structured sub-processes and dynamically re-allocating the at least one structured sub-process to another compute resource based on the failure or performance issue.

In some examples described herein, the allocation scheme may be developed using a generative AI model of the LLM. In some examples described herein, the one or more operational constraints may be provided by a user of the data processing system. In some examples described herein, the one or more operational constraints may be identified by the LLM.

The following provides an overview of aspects of the present disclosure:
Aspect 1: A method of data processing, comprising: receiving, by a data processing system, an indication of one or more operational constraints for an unstructured compute process to be executed by the data processing system; transmitting, to a LLM that is configured to communicate with the data processing system, a request to decompose the unstructured compute process into a plurality of structured sub-processes and allocate the plurality of structured sub-processes to a plurality of compute resources of the data processing system in accordance with the one or more operational constraints; receiving, from the LLM, a response comprising information associated with an allocation scheme for the plurality of structured sub-processes of the unstructured compute process; allocating, by the data processing system, the plurality of structured sub-processes identified by the LLM to the plurality of compute resources of the data processing system in accordance with the allocation scheme and the one or more operational constraints; and executing, by the plurality of compute resources of the data processing system, the plurality of structured sub-processes based at least in part on using the LLM to retrieve data from a plurality of data sources in accordance with the one or more operational constraints.
Aspect 2: The method of aspect 1, wherein allocating the plurality of structured sub-processes comprises: dynamically adjusting a quantity of the plurality of compute resources to which the plurality of structured sub-processes are allocated based at least in part on performance data associated with the plurality of structured sub-processes.
Aspect 3: The method of any of aspects 1 through 2, further comprising: decomposing the unstructured compute process into the plurality of structured sub-processes based at least in part on a complexity of the unstructured compute process, a quantity of compute resources available to execute the unstructured compute process, and respective processing capabilities of the available compute resources.
Aspect 4: The method of any of aspects 1 through 3, wherein allocating the plurality of structured sub-processes to the plurality of compute resources comprises: allocating at least one structured compute sub-process to a first compute resource of the plurality of compute resources based at least in part on a likelihood of the first compute resource successfully completing the at least one structured compute sub-process.
Aspect 5: The method of any of aspects 1 through 4, further comprising: re-allocating at least one structured sub-process from a first compute resource to a second compute resource based at least in part on a change to the one or more operational constraints for the unstructured compute process.
Aspect 6: The method of any of aspects 1 through 5, further comprising: allocating multiple instances of a structured sub-process to different compute resources of the data processing system to support failure recovery and fault tolerance.
Aspect 7: The method of any of aspects 1 through 6, further comprising: generating a process dependency graph that contains information associated with the plurality of structured sub-processes and the plurality of compute resources to which the plurality of structured sub-processes are allocated.
Aspect 8: The method of any of aspects 1 through 7, further comprising: updating the allocation scheme for the plurality of structured sub-processes of the unstructured compute process based at least in part on feedback information provided by the plurality of compute resources.
Aspect 9: The method of any of aspects 1 through 8, wherein the plurality of structured sub-processes comprise searching one or more online data sources, searching one or more databases, or interacting with one or more third-party systems.
Aspect 10: The method of any of aspects 1 through 9, wherein the plurality of compute resources comprise a network of AI bots that are capable of executing the plurality of structured sub-processes.
Aspect 11: The method of any of aspects 1 through 10, wherein the one or more operational constraints comprise a time constraint for the unstructured compute process, a quality constraint for the unstructured compute process, a processing cost constraint for the unstructured compute process, a resource capability constraint for the unstructured compute process, or any combination thereof.
Aspect 12: The method of any of aspects 1 through 11, wherein the allocation scheme identifies the plurality of structured sub-processes into which the unstructured compute process is to be decomposed, the plurality of compute resources to which the plurality of structured sub-processes are to be assigned, and a projected set of operational constraints for the unstructured compute process.
Aspect 13: The method of any of aspects 1 through 12, further comprising: monitoring a completion status of one or more ongoing structured sub-processes, wherein allocating the plurality of structured sub-processes to the plurality of compute resources is based at least in part on the completion status.
Aspect 14: The method of any of aspects 1 through 13, further comprising: using a machine learning model to predict a likelihood of a first compute resource successfully completing a first structured sub-process, wherein the machine learning model is trained on historic performance data associated with the first compute resource; and allocating the first structured sub-process to the first compute resource if the likelihood is above a threshold.
Aspect 15: The method of any of aspects 1 through 14, further comprising: detecting a failure or performance issue associated with execution of at least one structured sub-process of the plurality of structured sub-processes; and dynamically re-allocating the at least one structured sub-process to another compute resource based at least in part on the failure or performance issue.
Aspect 16: The method of any of aspects 1 through 15, wherein the allocation scheme is developed using a generative AI model of the LLM.
Aspect 17: The method of any of aspects 1 through 16, wherein the one or more operational constraints are provided by a user of the data processing system.
Aspect 18: The method of any of aspects 1 through 17, wherein the one or more operational constraints are identified by the LLM.
Aspect 19: An apparatus, comprising: at least one memory storing code; and one or more processors coupled with the at least one memory, wherein the one or more processors are individually or collectively operable to execute the code to cause the apparatus to perform a method of any of aspects 1 through 18.
Aspect 20: An apparatus, comprising: at least one means for performing a method of any of aspects 1 through 18.
Aspect 21: A non-transitory computer-readable medium storing code for data processing, the code comprising instructions executable by one or more processors to perform a method of any of aspects 1 through 18.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method of data processing, comprising:
receiving, by a data processing system, an indication of one or more operational constraints for an unstructured compute process to be executed by the data processing system;
transmitting, to a large language model (LLM) that is configured to communicate with the data processing system, a request to decompose the unstructured compute process into a plurality of structured sub-processes and allocate the plurality of structured sub-processes to a plurality of compute resources of the data processing system in accordance with the one or more operational constraints;
receiving, from the LLM, a response comprising information associated with an allocation scheme for the plurality of structured sub-processes of the unstructured compute process;
allocating, by the data processing system, the plurality of structured sub-processes identified by the LLM to the plurality of compute resources of the data processing system in accordance with the allocation scheme and the one or more operational constraints; and
executing, by the plurality of compute resources of the data processing system, the plurality of structured sub-processes based at least in part on using the LLM to retrieve data from a plurality of data sources in accordance with the one or more operational constraints.

2. The method of claim 1, wherein allocating the plurality of structured sub-processes comprises:
dynamically adjusting a quantity of the plurality of compute resources to which the plurality of structured sub-processes are allocated based at least in part on performance data associated with the plurality of structured sub-processes.

3. The method of claim 1, further comprising:
decomposing the unstructured compute process into the plurality of structured sub-processes based at least in part on a complexity of the unstructured compute process, a quantity of compute resources available to execute the unstructured compute process, and respective processing capabilities of the available compute resources.

4. The method of claim 1, wherein allocating the plurality of structured sub-processes to the plurality of compute resources comprises:
allocating at least one structured compute sub-process to a first compute resource of the plurality of compute resources based at least in part on a likelihood of the first compute resource successfully completing the at least one structured compute sub-process.

5. The method of claim 1, further comprising:
re-allocating at least one structured sub-process from a first compute resource to a second compute resource based at least in part on a change to the one or more operational constraints for the unstructured compute process.

6. The method of claim 1, further comprising:
allocating multiple instances of a structured sub-process to different compute resources of the data processing system to support failure recovery and fault tolerance.

7. The method of claim 1, further comprising:
generating a process dependency graph that contains information associated with the plurality of structured sub-processes and the plurality of compute resources to which the plurality of structured sub-processes are allocated.

8. The method of claim 1, further comprising:
updating the allocation scheme for the plurality of structured sub-processes of the unstructured compute process based at least in part on feedback information provided by the plurality of compute resources.

9. The method of claim 1, wherein the plurality of structured sub-processes comprise searching one or more online data sources, searching one or more databases, or interacting with one or more third-party systems.

10. The method of claim 1, wherein the plurality of compute resources comprise a network of artificial intelligence (AI) bots that are capable of executing the plurality of structured sub-processes.

11. The method of claim 1, wherein the one or more operational constraints comprise a time constraint for the unstructured compute process, a quality constraint for the unstructured compute process, a processing cost constraint for the unstructured compute process, a resource capability constraint for the unstructured compute process, or any combination thereof.

12. The method of claim 1, wherein the allocation scheme identifies the plurality of structured sub-processes into which the unstructured compute process is to be decomposed, the plurality of compute resources to which the plurality of structured sub-processes are to be assigned, and a projected set of operational constraints for the unstructured compute process.

13. The method of claim 1, further comprising:
monitoring a completion status of one or more ongoing structured sub-processes, wherein allocating the plurality of structured sub-processes to the plurality of compute resources is based at least in part on the completion status.

14. The method of claim 1, further comprising:
using a machine learning model to predict a likelihood of a first compute resource successfully completing a first structured sub-process, wherein the machine learning model is trained on historic performance data associated with the first compute resource; and
allocating the first structured sub-process to the first compute resource if the likelihood is above a threshold.

15. The method of claim 1, further comprising:
detecting a failure or performance issue associated with execution of at least one structured sub-process of the plurality of structured sub-processes; and
dynamically re-allocating the at least one structured sub-process to another compute resource based at least in part on the failure or performance issue.

16. The method of claim 1, wherein the allocation scheme is developed using a generative artificial intelligence (AI) model of the LLM.

17. The method of claim 1, wherein the one or more operational constraints are provided by a user of the data processing system.

18. The method of claim 1, wherein the one or more operational constraints are identified by the LLM.

19. An apparatus, comprising:
at least one memory storing code; and
one or more processors coupled with the at least one memory, wherein the one or more processors are individually or collectively operable to execute the code to cause the apparatus to:
receive, by a data processing system, an indication of one or more operational constraints for an unstructured compute process to be executed by the data processing system;
transmit, to a large language model (LLM) that is configured to communicate with the data processing system, a request to decompose the unstructured compute process into a plurality of structured sub-processes and allocate the plurality of structured sub-processes to a plurality of compute resources of the data processing system in accordance with the one or more operational constraints;
receive, from the LLM, a response comprising information associated with an allocation scheme for the plurality of structured sub-processes of the unstructured compute process;
allocate, by the data processing system, the plurality of structured sub-processes identified by the LLM to the plurality of compute resources of the data processing system in accordance with the allocation scheme and the one or more operational constraints; and
execute, by the plurality of compute resources of the data processing system, the plurality of structured sub-processes based at least in part on using the LLM to retrieve data from a plurality of data sources in accordance with the one or more operational constraints.

20. A non-transitory computer-readable medium storing code for data processing, the code comprising instructions executable by one or more processors to:
receive, by a data processing system, an indication of one or more operational constraints for an unstructured compute process to be executed by the data processing system;
transmit, to a large language model (LLM) that is configured to communicate with the data processing system, a request to decompose the unstructured compute process into a plurality of structured sub-processes and allocate the plurality of structured sub-processes to a plurality of compute resources of the data processing system in accordance with the one or more operational constraints;
receive, from the LLM, a response comprising information associated with an allocation scheme for the plurality of structured sub-processes of the unstructured compute process;
allocate, by the data processing system, the plurality of structured sub-processes identified by the LLM to the plurality of compute resources of the data processing system in accordance with the allocation scheme and the one or more operational constraints; and
execute, by the plurality of compute resources of the data processing system, the plurality of structured sub-processes based at least in part on using the LLM to retrieve data from a plurality of data sources in accordance with the one or more operational constraints.
